(19) United States
(12) Patent Application Publication
(10) Pub. No.: US 2026/0274243 A1
(43) Pub. Date: Sep. 17, 2026

(54) CONTROL METHOD OF HYBRID VEHICLE AND CONTROL DEVICE OF HYBRID VEHICLE

(71) Applicant: NISSAN MOTOR CO., LTD., Yokohama-shi (JP)

(72) Inventor: Atsushi TEZUKA, Kanagawa (JP)

(73) Assignee: NISSAN MOTOR CO., LTD., Yokohama-shi (JP)

(21) Appl. No.: 19/562,683

(22) Filed: Mar. 10, 2026

(30) Foreign Application Priority Data
Mar. 11, 2025 (JP) 2025-038580

(51) Int. Cl. B60W 20/13

(52) U.S. Cl. CPC B60W 20/13; B60W 2510/244; B60W 2520/10; B60W 2520/28; B60W 2552/35

(57) ABSTRACT

A control method of a hybrid vehicle including an engine and a battery includes: detecting that a front wheel has passed over a road surface irregularity based on a wheel speed change of the front wheel; and starting the engine at a timing when a rear wheel passes over the road surface irregularity.

### CROSS REFERENCE TO RELATED APPLICATIONS

The entire disclosure of Japanese Patent Application No. 2025-038580 filed Mar. 11, 2025 is expressly incorporated by reference herein.

### TECHNICAL FIELD

The present invention relates to a control method of a hybrid vehicle and a control device of a hybrid vehicle.

### BACKGROUND ART

A control method for controlling an engine start timing of a hybrid vehicle is known (see Literature 1: JP 2009-280139 A).

### SUMMARY OF THE INVENTION

In the control method of the hybrid vehicle described in Literature 1, an engine may be started while the hybrid vehicle is traveling on a smooth road surface with substantially no roughness. This may cause the occupants to perceive noise and vibration associated with engine start-up.

An object of the invention is to provide a control method of a hybrid vehicle and a control device of a hybrid vehicle that can make it less likely for the occupants to perceive noise and vibration during engine start-up.

According to an aspect of the invention, in a hybrid vehicle, it is detected that a front wheel has passed over a road surface irregularity, and an engine is started at a timing when a rear wheel passes over the road surface irregularity.

### BRIEF DESCRIPTION OF DRAWINGS

FIG. 1 illustrates a schematic configuration of a hybrid vehicle according to an exemplary embodiment.

FIG. 2 is a block diagram of a control device of the hybrid vehicle.

FIG. 3 is a flowchart of a control method of the hybrid vehicle.

FIG. 4 illustrates a relationship between a vehicle speed and a road-surface-irregularity determination threshold.

FIG. 5 is a time chart for explaining the control method of the hybrid vehicle.

FIG. 6 illustrates a relationship between a state of charge (SOC) of a battery and the road-surface-irregularity determination threshold.

### DETAILED DESCRIPTION

An exemplary embodiment of the invention will be described below with reference to the attached drawings.

Hereinafter, a driving force request operation by a driver through an accelerator operation unit such as an accelerator pedal is referred to as an “accelerator operation”, and an operation amount of the operation is referred to as an “accelerator operation amount”.

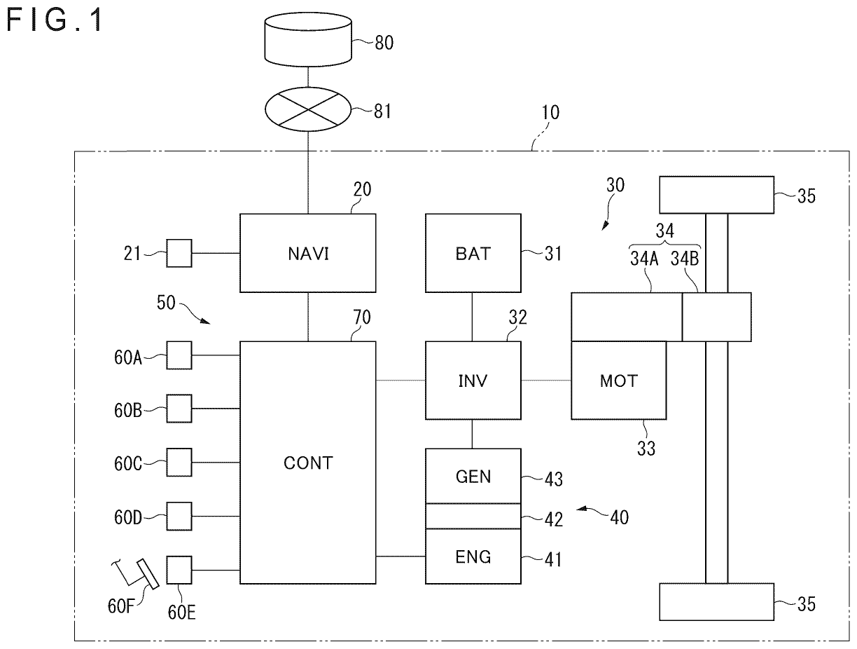

FIG. 1 illustrates a schematic configuration of a vehicle 10.

The vehicle 10 is a so-called series hybrid vehicle, in which electric power generated by a generator 43 using power of an engine 41 is supplied to a battery 31 and an electric motor 33 is rotated by the electric power of the battery 31, thereby driving wheels 35 to propel the vehicle.

The vehicle 10 includes a navigation device 20, a drive device 30, a power generating device 40, and a control device 50.

The navigation device 20 is implemented by a computer including: a memory device such as a Read Only Memory (ROM) and a Random Access Memory (RAM); a calculating device such as a Central Processing Unit (CPU) and a Central Graphics Processing Unit (GPU); and an input-output unit such as an input-output interface. The navigation device 20 is capable of receiving positional information of the vehicle 10 from a position sensor 21 such as a Global Navigation Satellite System (GNSS) and communicating with a server 80 via a network 81. The navigation device 20 acquires from the server 80 map information within a predetermined distance around the vehicle 10, statistical information accompanying the map information, and driving environment information accompanying the map information. When a destination is set by the occupants, for example, the navigation device 20 searches a route from a current position to the destination to set a planned driving route, displays the set driving route on an in-vehicle display together with the information acquired from the server 80, provides voice guidance through a speaker(s), and outputs the driving route to the control device 50. The map information includes road information associated with each point, where the road information is defined by nodes, links connecting the nodes, and identification numbers of the nodes and links. In the road information, information related to intersections and information related to roads are stored in association with the identification numbers of the respective links. The information related to intersections includes intersection locations, intersection approach directions, intersection types, and other intersection-related information. The information related to roads includes road types such as expressways and toll roads, road widths, road geometry, road surface roughness, road speed limit, elevation, average gradient, and other road-related information. Of the above information related to roads, the road surface roughness is defined in stepwise numerical levels, for example, in five levels or ten levels. In the statistical information, for example, a statistical average speed of vehicles traveling in a road section identified by the identification number of a corresponding link, and locations in which a vehicle stopping frequency is statistically high are stored for the identification numbers of the respective links. The driving environment information includes weather information and traffic information. The weather information includes, for example, outdoor temperature, solar radiation, and wind speed. The traffic information includes, for example, traffic volume, traffic congestion information, and construction information in a road section identified by the identification number of a corresponding link.

The drive device 30 includes the battery 31, an inverter 32, the electric motor 33, a reduction gear 34, and the wheels 35.

The battery 31 is a rechargeable battery that can be charged using electric power supplied from the generator 43 or an external charger. The battery 31 may be, for example, a lithium-ion battery or a nickel-metal hydride battery.

The inverter 32 converts direct current input from the battery 31 to alternating current and outputs the alternating current to the electric motor 33. The inverter 32 converts alternating current input from the electric motor 33 to direct current and inputs the direct current to the battery 31.

The electric motor 33 is driven in response to the input from the inverter 32, and generates driving force and regenerative braking force of the vehicle 10.

The reduction gear 34, which includes a transmission 34A and a differential gear 34B, reduces the output rotation of the electric motor 33 and transmits the reduced rotation to the wheels 35.

The power generating device 40 includes the inverter 32, the engine 41, a speed increaser 42, and the generator 43.

The engine 41 is mechanically connected to the generator 43 via the speed increaser 42. The engine 41 is not used as a power source to propel the vehicle 10, but as a power source to drive the generator 43 to generate electric power.

The generator 43 is configured to generate electric power by rotating through power from the engine 41 and to be capable of charging the battery 31. By using electric power of the battery 31, the generator 43 is capable of, for example: rotating an output shaft of the engine 41 to perform cranking during start-up of the engine 41; performing motoring in which the engine 41 is rotated as a load to consume electric power when a State of Charge (SOC) as a charge rate of the battery 31 is high; and generating vacuum in an intake passage by closing a throttle valve of the engine 41 when vacuum for brake pedal assist is necessary. The SOC of the battery 31 can be obtained by, for example, a controller 70 that acquires the SOC from the battery 31 or calculates the SOC from temperature, voltage, and current of the battery 31.

The control device 50 includes wheel speed sensors 60A, 60B, 60C and 60D, an accelerator position sensor 60E as an accelerator operation amount sensor, and the controller 70.

The wheel speed sensors 60A, 60B, 60C and 60D detect rotational speeds of the wheels 35 as wheel speeds. The wheel speed sensor 60A detects the wheel speed of a left front wheel, and the wheel speed sensor 60B detects the wheel speed of a right front wheel. The wheel speed sensor 60C detects the wheel speed of a left rear wheel, and the wheel speed sensor 60D detects the wheel speed of a right rear wheel.

The accelerator position sensor 60E detects an accelerator operation amount of the vehicle 10. The accelerator position sensor 60E is provided, for example, in the form of a pedal stroke sensor. The accelerator position sensor 60E detects an operation amount of an accelerator pedal 60F as the accelerator operation amount of the accelerator operation unit.

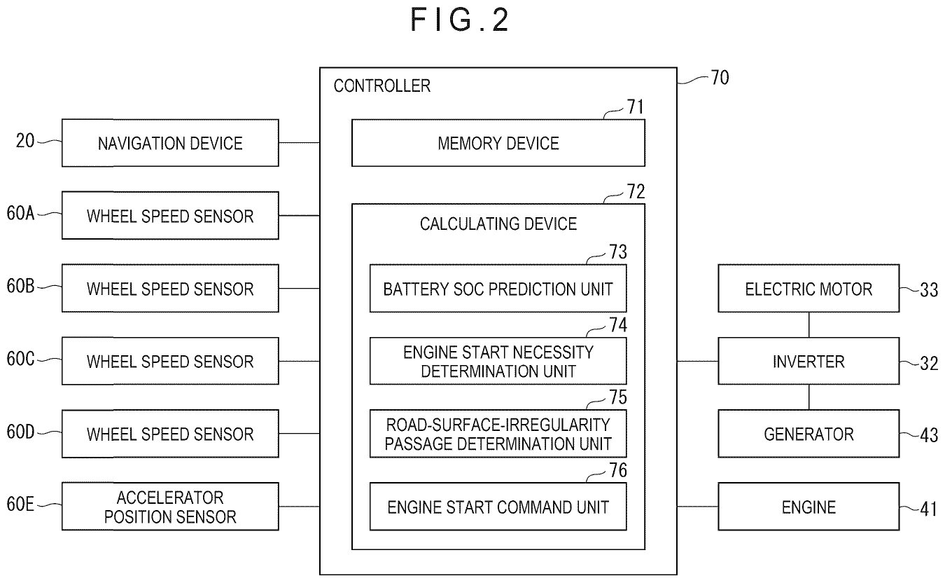

FIG. 2 is a block diagram of the control device 50 including the controller 70.

The controller 70 executes control of the engine 41 and control of the electric motor 33 and the generator 43 via the inverter 32. The controller 70 is implemented by a computer including: a memory device 71 such as a Read Only Memory (ROM) and a Random Access Memory (RAM); a calculating device 72 in the form of a processor such as a Central Processing Unit (CPU) and a Central Graphics Processing Unit (GPU); and an input-output unit such as an input-output interface. The navigation device 20, the inverter 32, the engine 41, the wheel speed sensors 60A, 60B, 60C and 60D, and the accelerator position sensor 60E are electrically or communicably connected to the controller 70.

The memory device 71 stores, for example, a computer program for causing the controller 70 to function, various maps used for control, and various parameter values. Examples of the maps stored in the memory device 71 include a map defining a relationship between a speed of the vehicle 10 (hereinafter, occasionally referred to as a vehicle speed) and a road-surface-irregularity determination threshold (hereinafter, simply referred to as an irregularity determination threshold), and a map defining a relationship between the accelerator operation amount and the vehicle speed, and a required driving force. Examples of the parameter values stored in the memory device 71 include various thresholds such as an engine start threshold with respect to the SOC of the battery 31 and the irregularity determination threshold with respect to a wheel speed change amount of a front wheel, specifications of the vehicle 10 such as a wheelbase, and specifications and characteristic values of the engine 41, the electric motor 33 and the generator 43.

The calculating device 72 includes a battery SOC prediction unit 73, an engine start necessity determination unit 74, a road-surface-irregularity passage determination unit 75, and an engine start command unit 76.

The battery SOC prediction unit 73 predicts a SOC transition along a planned driving route based on a current SOC of the battery 31, the map information, the statistical information, and the driving environment information. In the exemplary embodiment, the battery SOC prediction unit 73 calculates a power consumption of the vehicle 10 for each link in the road information of the planned driving route to the destination, i.e., for each road section identified by the identification number of a corresponding link, and subtracts the power consumption for each road section from the current SOC, thereby predicting the SOC transition. The power consumption for each road section is calculated from, for example, running loads such as running resistance, acceleration resistance and grade resistance of the vehicle 10 for each road section, losses of the electric motor 33, and internal losses of the battery 31. As values of these loads and losses, the battery SOC prediction unit 73 may use values stored in advance in the memory device 71, may acquire from the server 80 statistical averages of the values for the respective links in the road information, or may obtain the values by calculation. The running resistance of the vehicle 10 is obtained based on the vehicle speed, and the load due to the acceleration resistance is obtained based on a mass and speed of the vehicle 10. The load due to the grade resistance is obtained based on the mass of the vehicle 10 and road gradient. The losses of the electric motor 33 are obtained based on the rotational speed and torque of the electric motor 33, and the internal losses of the battery 31 are obtained based on the temperature, current and SOC of the battery 31.

The engine start necessity determination unit 74 determines whether or not it is necessary to start the engine 41 based on information on the SOC of the battery 31 in the planned driving route and information on road surface roughness in the planned driving route.

The road-surface-irregularity passage determination unit 75 detects that a front wheel has passed over a road surface irregularity based on a wheel speed change of the front wheel. Examples of the road surface irregularity includes a road joint, a manhole cover, a pothole caused by road surface deterioration, and a road marking such as an arrow and a speed limit marking painted on the road surface.

The engine start command unit 76 issues a command for starting the engine 41 based on a determination result of the engine start necessity determination unit 74, a determination result of the road-surface-irregularity passage determination unit 75, the vehicle speed, the accelerator operation amount, the specifications such as the wheelbase of the vehicle 10. In the exemplary embodiment, in a case where the road surface roughness remains equal to or less than a threshold and the SOC of the battery 31 will decrease to the engine start threshold if the engine 41 is not started, the engine start command unit 76 starts the engine 41 at a timing when a rear wheel passes over the road surface irregularity. In a case where the vehicle 10 is predicted to stop, the engine start command unit 76 does not start the engine 41 even when it is detected that a front wheel has passed over the road surface irregularity. The case where “the vehicle 10 is predicted to stop” includes, for example, a case where there is a location ahead at which the vehicle stopping frequency is statistically high, a case where there is a temporary stop point ahead, a case where a traffic light at an intersection ahead is to turn red, or a case where a vehicle in front is stopped.

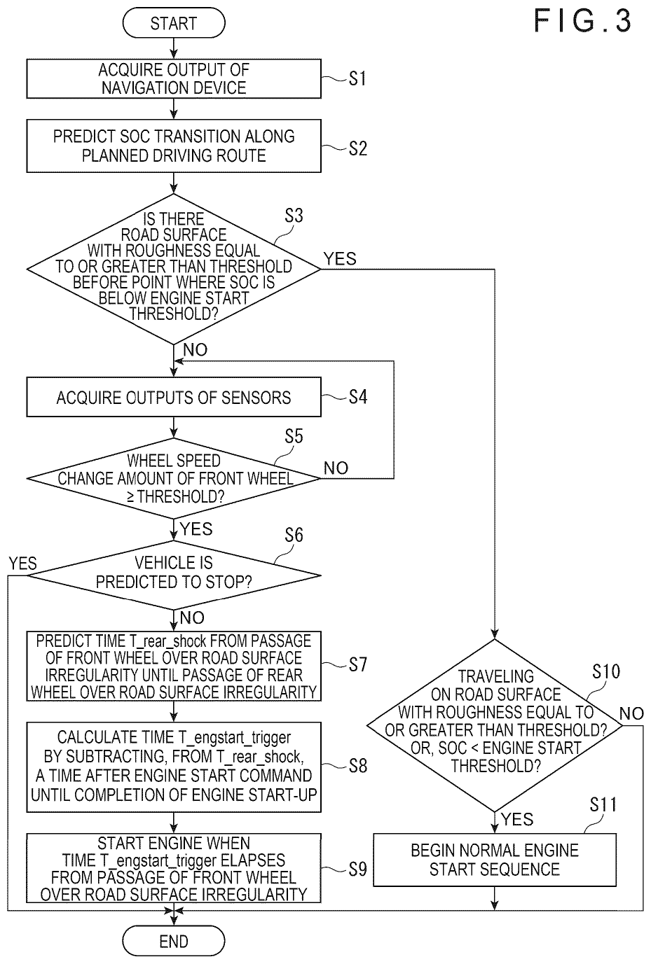

FIG. 3 is a flowchart of a control method executed by the controller 70. A control routine illustrated in the flowchart is programmed in advance and this program is installed on the controller 70. The controller 70 repeatedly executes the control routine as below at an operation cycle of, for example, approximately 10 to 100 milliseconds according to the program.

In Step S1 of FIG. 3, the controller 70 acquires the output of the navigation device 20, i.e., the map information including road surface roughness, the statistical information accompanying the map information, the driving environment information accompanying the map information, and a planned driving route.

In Step S2, the battery SOC prediction unit 73 predicts a SOC transition along the planned driving route based on a current SOC, the map information, the statistical information, and the driving environment information.

In Step S3, the engine start necessity determination unit 74 determines whether or not there is a road surface with roughness equal to or greater than the threshold before a point where the SOC is below the engine start threshold. When it is determined in Step S3 that there is no road surface with roughness equal to or greater than the threshold, the control routine proceeds to Step S4.

In Step S4, the controller 70 acquires the outputs of the sensors 60A, 60B, 60C, 60D and 60E, i.e., the wheel speeds and the accelerator operation amount.

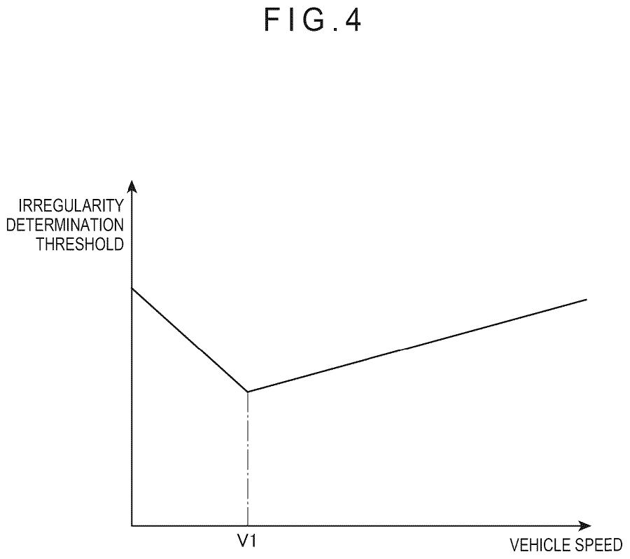

In Step S5, the road-surface-irregularity passage determination unit 75 determines whether or not a wheel speed change amount of a front wheel is equal to or greater than the irregularity determination threshold. In the exemplary embodiment, as illustrated in FIG. 4, the irregularity determination threshold changes according to the vehicle speed. Specifically, the irregularity determination threshold is set to increase as the vehicle speed is lower in a low speed range where the vehicle speed is at or below a value V1, whereas the irregularity determination threshold is set to increase as the vehicle speed is higher in a high speed range where the vehicle speed exceeds the value V1. In the low speed range, noise caused by driving decreases as the vehicle speed decreases, and therefore the irregularity determination threshold is increased according to the decrease in vehicle speed. In the high speed range, the noise caused by driving increases as the vehicle speed increases, and therefore the irregularity determination threshold is increased according to the increase in vehicle speed.

Referring back to FIG. 3, when it is not determined in Step S5 that the wheel speed change amount of the front wheel is equal to or greater than the irregularity determination threshold, the control routine returns to Step S4. On the other hand, when it is determined in Step S5 that the wheel speed change amount of the front wheel is equal to or greater than the irregularity determination threshold, the road-surface-irregularity passage determination unit 75 detects that the front wheel has passed over a road surface irregularity, after which the control routine proceeds to Step S6.

In Step S6, the engine start command unit 76 determines whether or not the vehicle 10 is predicted to stop. When the vehicle 10 is predicted to stop in Step S6, the engine 41 is not started. When the vehicle 10 is not predicted to stop in Step S6, the control routine proceeds to Step S7.

In Step S7, according to an equation (1) below, the engine start command unit 76 predicts a time T_rear_shock, which is a period of time from when the front wheel passes over the road surface irregularity until a rear wheel passes over the road surface irregularity.

$$T\_rear \_shock [ s ] = vehicle wheelbase [ m ] \div vehicle speed [ m / s ] \qquad ( 1 )$$

In the exemplary embodiment, the engine start command unit 76 predicts the vehicle speed after the front wheel has passed over the road surface irregularity based on the vehicle speed and the required driving force when the front wheel passes over the road surface irregularity, and uses the predicted vehicle speed as the vehicle speed in the above equation (1). The required driving force is obtained from the map defining the relationship between the accelerator operation amount and the vehicle speed, and the required driving force. For example, the engine start command unit 76 divides, by the mass of the vehicle 10, the required driving force when the front wheel passes over the road surface irregularity to calculate an acceleration of the vehicle 10, and reflects the calculated acceleration in the vehicle speed when the front wheel passes over the road surface irregularity, thereby predicting the vehicle speed until the rear wheel passes over the road surface irregularity.

In Step S8, according to an equation (2) below, the engine start command unit 76 subtracts a time T_eng_combustion from the time T_rear_shock. The time T_eng_combustion is a period of time after a command for starting the engine 41 is issued until start-up of the engine 41 is completed. The engine start command unit 76 thus calculates a time T_engstart_trigger, which is a period of time from when the front wheel passes over the road surface irregularity until the start-up of the engine 41 is completed at the same timing as the rear wheel passes over the road surface irregularity.

$$T\_engstart \_trigger = T\_rear \_shock - T\_eng \_combustion \qquad ( 2 )$$

In Step S9, when the time T_engstart_trigger elapses from a timing when the front wheel passes over the road surface irregularity, the engine start command unit 76 issues the command for starting the engine 41. Accordingly, the engine 41 is started at the timing when the rear wheel passes over the road surface irregularity.

On the other hand, when it is determined in Step S3 that there is the road surface with roughness equal to or greater than the threshold before a point where the SOC is below the engine start threshold, the engine start necessity determination unit 74 determines in Step S10 whether or not the vehicle 10 is traveling on the road surface with roughness equal to or greater than the threshold or whether or not the SOC of the battery 31 is below the engine start threshold. When it is determined in Step 10 that the vehicle 10 is traveling on the road surface with roughness equal to or greater than the threshold or that the SOC is below the engine start threshold, the engine start command unit 76 issues a command for beginning a normal start sequence of the engine 41 in Step S11. When it is determined otherwise, the engine start command unit 76 does not start the engine 41.

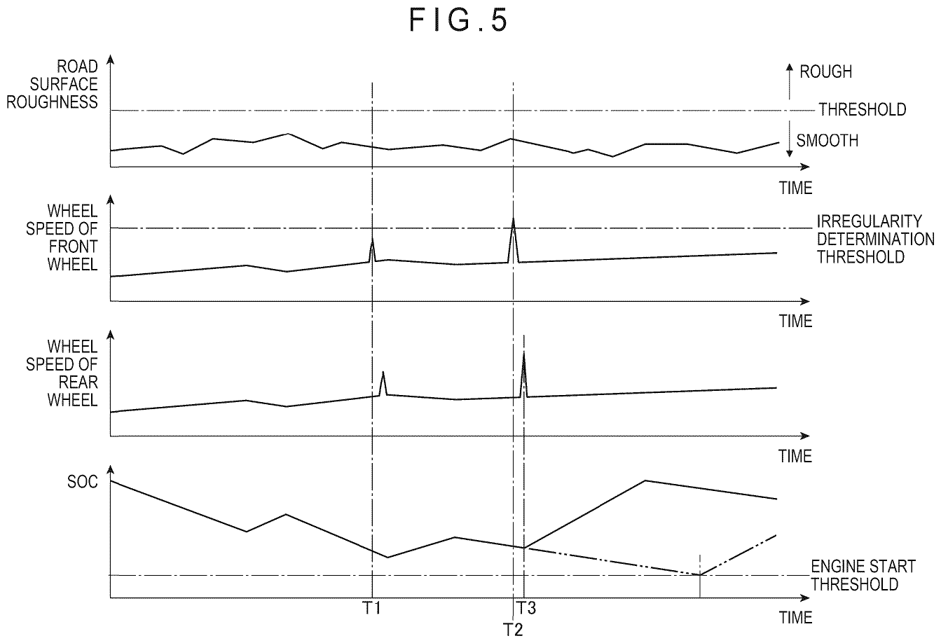

FIG. 5 is a time chart for explaining a control method of the vehicle 10.

In FIG. 5, the road surface roughness is below the threshold, which indicates that the vehicle 10 is traveling on a relatively smooth road surface. Even the relatively smooth road surface may have a road surface irregularity such as a manhole cover, which causes the wheel speed of a front wheel to fluctuate temporarily as illustrated at times T1 and T2 in FIG. 5. At the time T1, a wheel speed change amount of the front wheel is below the irregularity determination threshold, and noise and vibration when the front wheel passes over the road surface irregularity are not so significant. Therefore, starting the engine 41 may cause the occupants to perceive noise and vibration during the start-up of the engine 41. For the reason, the controller 70 does not detect that the front wheel has passed over the road surface irregularity and thus does not start the engine 41 when a rear wheel passes over the road surface irregularity.

On the other hand, when the wheel speed change amount of the front wheel is equal to or greater than the irregularity determination threshold as indicated at the time T2 in FIG. 5, the controller 70 detects that the front wheel has passed over a road surface irregularity. Then, the controller 70 calculates the time T_engstart_trigger, which is a period of time from the time T2 (i.e., the time when the front wheel passes over the road surface irregularity) until the start-up of the engine 41 is completed at the same timing as the rear wheel passes over the road surface irregularity, and the controller 70 issues a command for starting the engine 41 when the time T_engstart_trigger elapses from the time T2. Accordingly, the engine 41 is started at a time T3 when the rear wheel passes over the road surface irregularity, which can make it less likely for the occupants to perceive noise and vibration during the start-up of the engine 41.

If the above control method is not executed and the engine 41 is not started at the time T3, the SOC of the battery 31 decreases to the engine start threshold as indicated by a two-dot chain line in FIG. 5. This causes the engine 41 to start, thereby increasing the SOC. In contrast, according to the above control method, since the engine 41 is started when the rear wheel passes over the road surface irregularity, the SOC can be increased before it decreases to the engine start threshold.

According to the exemplary embodiment as described above, by detecting that a front wheel has passed over a road surface irregularity and starting the engine 41 at a timing when a rear wheel passes over the road surface irregularity, it is possible to make it less likely for the occupants to perceive noise and vibration during the start-up of the engine 41.

According to the exemplary embodiment, in a case where the road surface roughness of a planned driving route remains equal to or less than the threshold and the SOC of the battery 31 will decrease to the engine start threshold if the engine 41 is not started, the engine 41 is started at a timing when a rear wheel passes over a road surface irregularity. This can prevent the engine 41 from being inadvertently started while the hybrid vehicle is traveling on a smooth road surface with roughness equal to or less than the threshold, which makes it possible to prevent the occupants from perceiving noise and vibration during the start-up of the engine 41. In addition, since the engine 41 is started only when the SOC is low, fuel efficiency deterioration caused by increased start-up frequency can be prevented.

According to the exemplary embodiment, the lower the vehicle speed, the larger the irregularity determination threshold. Thus, as the vehicle speed is lower, the engine 41 is started when the vehicle 10 passes over a larger road surface irregularity. Therefore, the occupants are less likely to notice that the engine 41 is started during a low speed driving.

According to the exemplary embodiment, when the vehicle 10 is predicted to stop, the engine 41 is not started even when the controller 70 detects that a front wheel has passed over a road surface irregularity. In this case, since the vehicle 10 stops without the engine 41 being started, a state where the engine 41 is not started can be maintained during a vehicle stop where noise and vibration of the engine 41 are most noticeable. Accordingly, discomfort experienced by the occupants due to the noise and vibration of the engine 41 is reduced. Further, since energy consumption is low while the vehicle is stopped, there is no concern about a decrease in the SOC even when the engine 41 is not started, and a feeling of unease of the occupants is reduced.

According to the exemplary embodiment, the vehicle speed after a front wheel has passed over a road surface irregularity is predicted, and a period of time from when the front wheel passes over the road surface irregularity until a rear wheel passes over the road surface irregularity is calculated based on the predicted vehicle speed. Therefore, the timing when the rear wheel passes over the road surface irregularity can be obtained with good precision.

The best configuration, method, and the like for carrying out the invention are disclosed in the above description. The scope of the invention, however, is not limited thereto. Specifically, although the invention is particularly illustrated and described primarily with respect to a specific exemplary embodiment, those skilled in the art may make various modifications to the above exemplary embodiment in terms of shape, material, numerical quantity, and other detailed configurations without departing from the technical idea and the scope of the object of the invention. Further, the descriptions limiting the shapes, materials, and the like disclosed hereinabove are given as examples to facilitate understanding of the invention, and are not intended to limit the invention. Therefore, descriptions in which components are named without some or all of the limitations on shape, material, and the like are within the scope of the invention.

The vehicle 10 may include an inter-vehicle distance sensor capable of recognizing an object ahead and the distance to that object and/or a sensor for detecting objects around the vehicle 10, in order to recognize objects in the vicinity including a vehicle in front of the vehicle 10.

The vehicle 10 may be a parallel hybrid vehicle in which the wheels 35 may be driven by the electric motor 33 and the engine 41.

The vehicle 10 may be an all-wheel drive vehicle, a front-wheel drive vehicle, or a rear-wheel drive vehicle.

The navigation device 20 may not be an in-vehicle device, and may be provided in the form of the server 80 or a mobile terminal such as a smartphone or a tablet of the occupants. In this case, the map information, the statistical information, the driving environment information, the set driving route, and the like may be output from the server 80 or the mobile terminal to the controller 70.

The navigation device 20 may acquire, from a recording medium installed in the vehicle 10, information such as the map information and the statistical information recorded in the recording medium.

The road surface roughness acquired by the navigation device 20 may be included in the statistical information as statistical values obtained from vehicles traveling in a road section identified by the identification number of a corresponding link.

The transmission 34A may have a fixed gear ratio, may be capable of stepwise switching between multiple gear ratios, or may be capable of continuous switching between gear ratios such as a Continuously Variable Transmission (CVT).

The control device 50 is configured including the accelerator pedal 60F as the accelerator operation unit, and the accelerator position sensor 60E as the accelerator operation amount sensor. However, the control device 50 may be configured differently. For example, the accelerator operation unit may be provided in the form of an operation lever, an operation dial and the like, and the accelerator operation amount sensor may be provided in the form of sensors such as a stroke sensor and a potentiometer that detect operation amounts of the operation lever, operation dial and the like.

The controller 70 may use, as the wheel speed, values obtained by multiplying the rotational speed of the wheels 35 by a radius of the wheels 35.

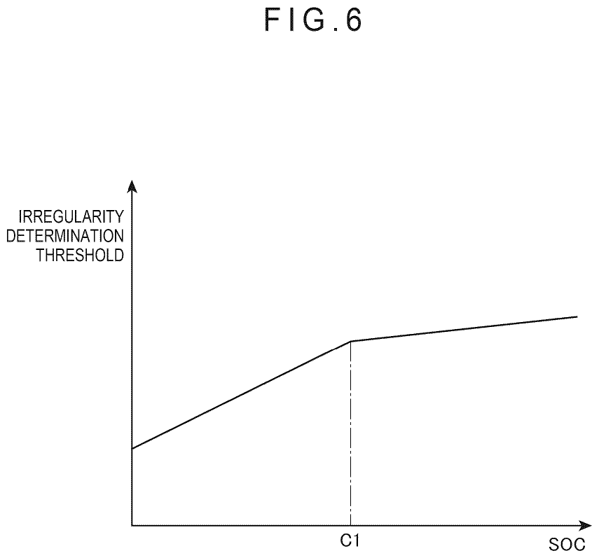

The irregularity determination threshold may be set changeable depending on the SOC of the battery 31 so that the irregularity determination threshold decreases as the SOC is smaller. For example, as illustrated in FIG. 6, the irregularity determination threshold may be set as follows: when the SOC is a value C1 or less, the rate of change in the irregularity determination threshold is larger than a case where the SOC exceeds the value C1, and the irregularity determination threshold decreases more rapidly as the SOC is smaller. The smaller the SOC, the higher a charge request for protection of the battery 31, i.e., a request for starting the engine 41. Thus, setting the irregularity determination threshold smaller makes it easier to start the engine 41. On the other hand, when the SOC exceeds the value C1, the request for starting the engine 41 relatively decreases. Therefore, a dependency on the SOC may be lowered, and the engine 41 only needs to be started in a case where a magnitude of shock (i.e., the wheel speed change amount of a front wheel) when the front wheel passes over a road surface irregularity increases to a certain level. When the SOC exceeds the value C1, the rate of change in the irregularity determination threshold may be small as illustrated in FIG. 6, or the irregularity determination threshold may not be changed, that is, set at a constant value.

The road-surface-irregularity passage determination unit 75 may detect that the front wheel has passed over a road surface irregularity when the wheel speed change amount of one of left and right front wheels is equal to or greater than the irregularity determination threshold, or when the wheel speed change amounts of both of the left and right front wheels are equal to or greater than the irregularity determination threshold.

The road-surface-irregularity passage determination unit 75 may detect that the front wheel has passed over a road surface irregularity by determining whether or not an angular acceleration obtained by differentiating the rotational speed of the front wheel is equal to or greater than the irregularity determination threshold.

The engine start command unit 76 may predict the vehicle speed after the front wheel has passed over a road surface irregularity by using a driving force generated by the electric motor 33 when the front wheel passes over the road surface irregularity, instead of the required driving force when the front wheel passes over the road surface irregularity. For example, the engine start command unit 76 may divide, by the mass of the vehicle 10, the driving force generated by the electric motor 33 when the front wheel passes over the road surface irregularity to calculate the acceleration of the vehicle 10, and reflect the calculated acceleration in the vehicle speed when the front wheel passes over the road surface irregularity, thereby predicting the vehicle speed until the rear wheel passes over the road surface irregularity.

The engine start command unit 76 may use the vehicle speed when the front wheel passes over the road surface irregularity as the vehicle speed in the above equation (1) for calculating the time T_rear_shock.

What is claimed is

1. A control method of a hybrid vehicle comprising an engine and a battery, the control method comprising:
detecting that a front wheel has passed over a road surface irregularity based on a wheel speed change of the front wheel; and
starting the engine at a timing when a rear wheel passes over the road surface irregularity.

2. The control method of a hybrid vehicle according to claim 1, wherein
information on road surface roughness of a planned driving route is acquired, and
the engine is started when the road surface roughness remains equal to or less than a threshold and an SOC of the battery will decrease to an engine start threshold without the engine being started.

3. The control method of a hybrid vehicle according to claim 1, wherein
the detection of the front wheel having passed over the road surface irregularity is performed when a wheel speed change amount of the front wheel is equal to or greater than a road-surface-irregularity determination threshold, and
the road-surface-irregularity determination threshold is increased as a speed of the vehicle is lower.

4. The control method of a hybrid vehicle according to claim 1, wherein
the detection of the front wheel having passed over the road surface irregularity is performed when a wheel speed change amount of the front wheel is equal to or greater than a road-surface-irregularity determination threshold, and
the road-surface-irregularity determination threshold is decreased as an SOC of the battery is smaller.

5. The control method of a hybrid vehicle according to claim 1, wherein
when the vehicle is predicted to stop, the engine is not started even when it is detected that the front wheel has passed over the road surface irregularity.

6. The control method of a hybrid vehicle according to claim 1, wherein
a vehicle speed after the front wheel has passed over the road surface irregularity is predicted based on a vehicle speed and a required driving force when the front wheel passes over the road surface irregularity, and
a period of time from when the front wheel passes over the road surface irregularity until the rear wheel passes over the road surface irregularity is calculated based on the vehicle speed predicted.

7. A control device of a hybrid vehicle comprising an engine and a battery, the control device comprising:
a sensor configured to detect a wheel speed of a front wheel; and
a controller configured to control start-up of the engine, wherein the controller is configured to:
detect that the front wheel has passed over a road surface irregularity based on a wheel speed change of the front wheel; and
start the engine at a timing when a rear wheel passes over the road surface irregularity.
